(19) United States
(12) Patent Application Publication
(10) Pub. No.: US 2024/0202648 A1
(43) Pub. Date: Jun. 20, 2024

(54) PAYLOAD VERIFICATION FOR UNMANNED AERIAL VEHICLE DELIVERIES

(71) Applicant: Zipline International Inc., South San Francisco, CA (US)

(72) Inventors: Benjamin Skilling Alderfer, South San Francisco, CA (US); Ivan Chen Wang, South San Francisco, CA (US)

(21) Appl. No.: 18/544,773

(22) Filed: Dec. 19, 2023

Related U.S. Application Data
(60) Provisional application No. 63/476,137, filed on Dec. 19, 2022.

(51) Int. Cl. G06Q 10/0832

(52) U.S. Cl. CPC G06Q 10/0832; B64U 2101/00

(57) ABSTRACT

A computer implemented method includes receiving, from a user device, a request to view a user interface including a plurality of products for delivery by an unmanned aerial vehicle (UAV) as part of an order associated with the user device. One or more unviable products are identified from the plurality of products based on the order, one or more delivery constraints of the UAV, and one or more characteristics of the plurality of products. The user interface including the plurality of products is displayed at the user device. The one or more unviable products are displayed with indicators that the one or more unviable products will exceed the delivery constraints of the UAV.

### CROSS REFERENCE TO RELATED APPLICATIONS

This application claims the benefit of priority under 35 USC § 119(e) of U.S. Provisional Patent Application No. 63/476,137 filed 19 Dec. 2022 and entitled “CAPACITY VERIFICATION FOR UAV DELIVERIES,” which is hereby incorporated by reference in its entirety.

### BACKGROUND

Mobile applications, websites, and other systems are increasingly used by consumers to order various goods for delivery to consumers. However, many ordering systems and platforms do not take into account physical constraints or preferences that may impact customer orders. For example, the delivery vehicles or packaging for orders may include constraints that may have an impact on a customer's order, but that are not relayed to the customer as part of the ordering processing. Further, as delivery of consumer goods using unmanned aerial vehicles, such as unmanned aerial vehicles (UAVs) increases, similar applications may be used for delivery by UAV. However, existing applications may not accommodate or account for aspects of the ordering and delivery process and/or provide information to the consumer regarding order selections and impact on the overall delivery experience.

### SUMMARY

An example computer implemented method is disclosed herein. The method includes receiving, from a user device, a request to view a user interface including a plurality of products for delivery by an unmanned aerial vehicle (UAV) as part of an order associated with the user device. One or more unviable products are identified from the plurality of products based on the order, one or more delivery constraints of the UAV, which includes one or more capacity limits of the UAV, and one or more characteristics of the plurality of products. The user interface including the plurality of products is displayed at the user device. The one or more unviable products are displayed with indicators that the one or more unviable products will exceed the delivery constraints of the UAV.

An additional example computer implemented method is disclosed herein. The method includes displaying, on a user device, a plurality of products available for delivery and receiving a user input to add a new product from the plurality of products to an order. The method further includes analyzing product data from one or more products in the order and the new product in light of one or more delivery constraints and determining that the order with the addition of the new product will exceed the one or more delivery constraints. The method further includes generating a user notification on the user device to indicate that the addition of the new product will exceed the one or more delivery constraints.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 illustrates an example system including user devices in communication with a retail application for delivery of products using an unmanned aerial vehicle (UAV), in accordance with various examples described herein.

FIG. 2 illustrates a schematic diagram of an example retail application, in accordance with various examples described herein.

FIG. 3 is a schematic diagram of an example computer system implementing various embodiments in the examples described herein.

FIG. 4 shows an example user interface of the retail application, in accordance with various examples described herein.

FIG. 5 shows an example user interface of the retail application, in accordance with various examples described herein.

FIG. 6 is a flow diagram of operations for generating the product data used for delivery constraint verification, in accordance with various examples described herein.

FIG. 7 is a flow diagram of operations for rendering a user interface of a retail application, in accordance with various examples described herein.

### DETAILED DESCRIPTION

Mobile applications, websites, and other systems are commonly used for order and delivery of various products to consumers. For example, mobile applications may allow consumers place an order including multiple products for groceries from a grocery store, and the order may be delivered to the consumer through, for example, a service of the retailer or a third party delivery provider. Such services and delivery providers generally use automobiles, trucks, or other ground-based transportation to complete deliveries. Accordingly, such deliveries may be delayed due to traffic, road construction, or other ground conditions. Further, delivery vehicles may be held at a retailer, warehouse, or other location where products are located until a certain number of orders are placed to reduce the number of trips made by the delivery vehicles. Many current delivery systems also include human operators, such as drivers, that are responsible for picking, packing, and delivery of the products to the end consumer.

Unmanned aerial vehicles (UAVs) may be used to complete deliveries quicker and more efficiently, as UAVs may not be subject to ground conditions and may not be constrained by human performance. Further, UAVs may be used to make faster deliveries, as a single UAV may be sent directly from a retailer to a consumer or from facility to facility in an intracompany delivery, without waiting for additional nearby consumers to place orders for delivery (e.g. a point to point delivery system). However, UAVs may have size constraints on deliveries. For example, a UAV may have dimensional (e.g., linear or volumetric measurement) limits and/or weight limits for each order carried by the UAV to ensure that the order will actually fit within the designated cargo or payload space within the UAV, to ensure that the weight does not negatively impact the UAV's ability to fly and maneuver, and/or to ensure that the order can be delivered safely and accurately from the aerial location to a ground or other delivery location. Such limits may reduce the number and type of items which may be delivered as part of the same order. Further, there may be other types of constraints, such as those that may impact the quality or other characteristics of the product or payload. For example, certain payloads may require specialized packaging/transportation features (e.g., hazmat or insulation) that may be only be provided in select UAVs or may require delivery by separate UAVs (e.g., two or more vehicles may be required to delivery an order). As another example, certain payloads may have temperature sensitivities that may impact other payloads with different temperature characteristics and additional vehicles may be used to enable delivery of goods with similar temperatures.

Similarly, with conventional delivery vehicles or methods (e.g. ground shipping or delivery), there may be packaging constraints (such as the size of a package) or vehicle constraints, such as a cargo space or payload capacity, that may impact the delivery (e.g. change the number of separate deliveries, change number or size of packaging, increase timing due to vehicle changes).

Applications used for conventional vehicle deliveries may not account for these types of constraints of orders for delivery, especially in point to point to business to consumer deliveries. For example, such applications may generally notify a customer after an order is placed if an item is unavailable or otherwise undeliverable, which may require numerous computing resources down the line that process the order, begin to pack the order, charge the user for the order, and then have to reverse the entire process. Accordingly, such applications may be unworkable to enable efficient and fast ordering processes. These systems may be particularly difficult with added size constraints for UAVs. For example, a customer may place a large order in the application and pay for the order before items are cancelled for exceeding dimensional or weight limits of the UAV. As a result, computing resources may be utilized to refund payments and to cancel orders that have already been processed, which further may impact UAV fleet management as scheduled deliveries and UAV resources need to be modified or re-routed. Further, customers may be unable to choose which products or items are cancelled from their orders which may lead to customers placing additional orders (and utilizing additional UAVs) in order to receive urgently needed items.

The retail application disclosed herein generally provides a user interface for ordering products for delivery by UAV. In some examples, the retail application may provide delivery of products from retailer to end user. In other examples, the retail application may provide intracompany deliveries from facility to facility, as such the discussion of any “order” or delivery recipient is meant to encompass both third part and intra-party transit of goods. The retail application includes delivery viability of a payload, e.g., via verification features, such that customers or users are notified before or as they are placing an order when certain products will cause the order to exceed delivery constraints of the UAV. Delivery constraints may include capacity and payload constraints of the UAV, constraints based on characteristics of the product, constraints based on characteristics of the retailer, and constraints based on the delivery route, e.g., temperature requirements for a product that do not match with an insulation or cargo hold temperature of the UAV, edible characteristics that do not match with a cargo rating of a UAV, size constraints of the overall payload that would exceed a cargo capacity for a UAV, etc. For example, the retail application may provide a user interface showing products available for delivery. When an item is added to an order (e.g., when a user adds an item to a cart within the application), the retail application may update the user interface to show which products may be added to the customer's order without exceeding capacity and payload constraints. Accordingly, items which exceed capacity and payload constraints are not added to the order before completion, and the customer is able to prioritize urgently needed items.

Further, the dynamic display and assessment of capacity allows a user to be strategic in placing an order. For example, if a user has placed items totaling a weight of fourteen kilograms into an order and the UAV has a payload weight limit of fifteen kilograms, then if the user interface will restrict the user from placing any item over one kilogram into the order or will offer to split the order into multiple payloads to maintain a viable delivery.

In other examples, the delivery constraints may be based on other characteristics of the product. For example certain cold products may require delivery within a certain temperature range. In such examples, adding the product to the same payload may not be viable if the payload already contains hot products or products which require delivery at a different temperature range, and the user interface may be configured to reflect that a delivery constraint has been violated. For example, if an order already contains ice cream, which requires delivery at a certain low temperature range, then if a user tries to place a hot item in the order, the user interface may display a warning that the items cannot be delivered in the same payload and may restrict placing the hot item into the order or offer to split the order into multiple payloads in order to maintain a viable delivery. In other examples, adding a product to the delivery may not be viable where the product contains fragile or hazardous materials which may not be placed with the other products in the payload.

In other examples, the delivery constraints may be based on a packaging requirement, such as the constraints due to a particular box size required for a particular order or to allow fit within a compartment or other area in a vehicle. In these instances, the system may provide notifications to a user as the user is browsing for products that additional selections may require a larger packaging size, may require that an order be split into multiple packages, and/or may increase a timing option as another vehicle or delivery method is required. Such notifications may be done based on dynamic calculations while the user is browsing, helping to prevent orders from being placed and then needing additional processing, to be reversed, and/or provide an undesirable customer experience. For example, a user can be alerted that adding a particular product to his or her order may result in the order being broken into multiple boxes, which may be undesirable from the customer point of view, as customers may be driven to minimize the number of packages or separate orders to help reduce the environmental impact of such deliveries (e.g., carbon used in transporting the order).

In other examples, the delivery constraints may be based on other characteristics of the retailer, such as the retailer's requirements for shipping and user experience. For example, a retailer may require that certain products are delivered in isolation without any other products in the same payload in order to provide a particular user experience with the order. For example, a retailer may require that flower bouquets are delivered as the sole item in the payload in order to protect the integrity of the bouquet and provide a more memorable gift delivery experience for the recipient.

In other examples, the delivery constraints may be based on characteristics of the delivery route. For example, the battery charge required in order to complete a certain delivery route may limit the total weight of products that may be delivered. In other examples, factors such as the weather, temperature, topographic features, and altitude changes along the route may impact the type of products that can be included in the payload.

In various examples, the retail application disclosed herein may communicate with user devices to display, on a user device, a plurality of products available for delivery. The retail application may receive a user input to add a new product from the plurality of products to an order and may analyze product data from one or more products in the order and the new product in light of one or more delivery constraints. The retail application may further determine that the order, with the addition of the new product, will exceed the one or more delivery constraints and may generate a notification on the user device to indicate that the addition of the new product will exceed the one or more delivery constraints. Such constraints may include, for example, vehicle constraints and packaging constraints (e.g., constraints based on user preference regarding a packaging size or packaging amount). In some examples, the retail application may prohibit the addition of the new product to the order.

In some embodiments, the system may allow dynamic updating of the assessment criteria, such as in response to regulatory or manufacturing changes (e.g., updated cargo capacity for a UAV or flight characteristics that may change). Similarly, changes to the delivery or storage criteria of the goods themselves, e.g., quality or temperature storage requirements, vibration or shaking, contamination requirements, or the like. As such, the system can dynamically update criteria for the goods, UAVs, and/or delivery routes to generate validation or notifications as a user is arranging goods into an order.

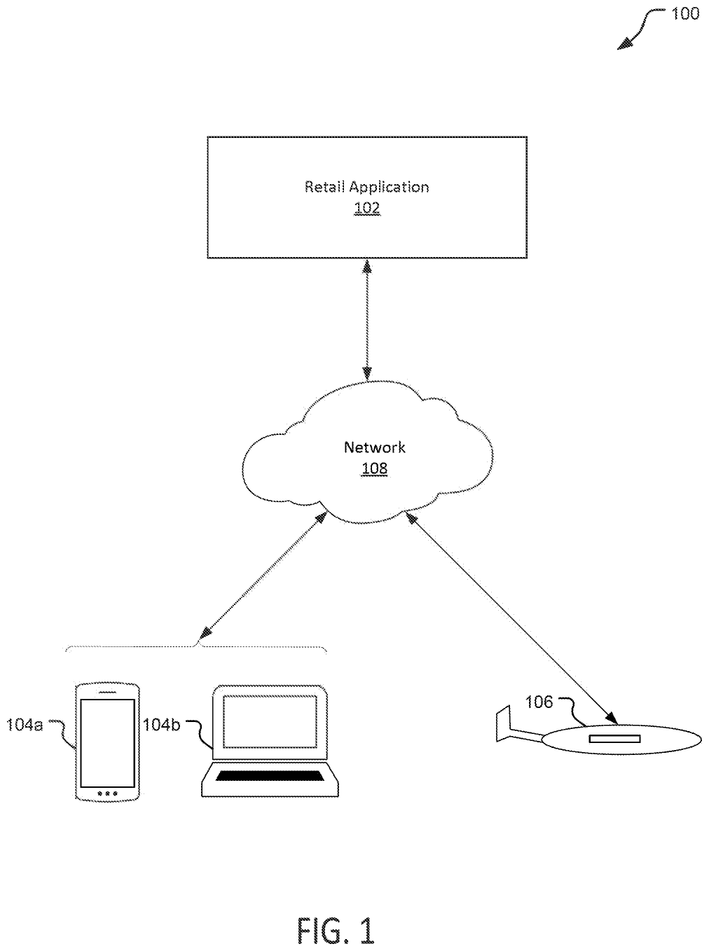

Various embodiments of the present disclosure will be explained below in detail with reference to the accompanying drawings. Other embodiments may be utilized, and structural, logical and electrical changes may be made without departing from the scope of the present disclosure. Turning now to the drawings, FIG. 1 illustrates an example system including various devices 104a and 104b in communication with a retail application 102, where the user application 102 is used to facilitate ordering and delivery of products using a UAV 106. It should be noted that although the various description includes examples of UAV delivery, the system and methods presented herein are applicable to all types of delivery platforms, such as traditional human manned vehicles and the like. As such, the discussion of any particular type of vehicle or delivery platform is meant as illustrative only. Turning back to FIG. 1, the retail application 102 may generally be accessible by consumers (e.g., through user devices 104a and/or 104b) to view products from one or more retailers available for delivery by UAV 106. The retail application 102 may further allow such consumers to place an order of one or more of the products for delivery by the UAV 106. In some examples, the retail application 102 may be associated with an individual retailer accessible, for example, through the retailer's website or mobile application. In some examples, the retail application 102 may be associated with a third party service delivering orders from one or more retailers through UAV.

To facilitate such orders, the retail application 102 may notify consumers, during the process of adding various products or items to an order, when such items are unavailable for delivery (e.g., unable to be added to the order) due to delivery constraints, where the delivery constraints may be determined based on the UAV 106, packaging constraints (e.g., packaging volume), personal preferences of the user (e.g., minimize packaging), or a combination of one or more other constraint types. Such notifications may be provided through a user interface to the retail application 102 displayed at a user device 104a or 104b as the user adds products to the order. Accordingly, a user may be notified before completion of an order that capacity limits have been reached, streamlining the order process for the consumer. Notification before an order is placed may also save processing resources, reduce trips made by UAVs, and result in a more efficient picking and packing process. For example, where capacity of a vehicle is not checked prior to checkout, consumer payment may be processed for the entire order, and part of the payment may later have to be refunded as items exceeding capacity of the vehicle are cancelled from the order, such aspects may require multiple server requests and processing flows that may limit computing resources for the system. Similarly, where products or items are cancelled after checkout, consumers often do not choose which items are removed from the order, which may result in urgently needed items or most desired products being cancelled from the order. In such cases, the consumer may place another order for delivery by UAV to ensure delivery of such urgently needed items requiring duplication of resources and impact across fleet management for the UAV fleet.

The retail application 102 may generally be implemented by or at a computing device or combinations of computing resources in various embodiments. In various examples, the retail application 102 may be implemented by one or more servers, cloud computing resources, and/or other computing devices. The retail application 102 may, for example, utilize various processing resources to facilitate ordering and delivery of retail products by UAV, and the like. The retail application 102 may further include memory and/or storage locations to store program instructions for execution by the processor and various data utilized by the retail application 102. The retail application 102 may be a mobile application, a website presented through a web browser (e.g., at a laptop or desktop computer), and the like. It should be noted that the term retail is meant to encompass almost any type of good or product that can be ordered from a provider, such as, but not limited to, consumer goods, food (both off the shelf and restaurant created), medical supplies, and the like. As such, the term retailer or retail application should be understood to encompass almost any type of provider or business that can provide goods or products to a user. In some instances, the retail application may be hosted on the retailer's system, such as a retailer based application. In other instances, the retail application may be hosted by the UAV fleet management that may interact and receive data from the retailer regarding available goods

Generally, the user devices 104a and 104b may be devices belonging to an end user, such as a consumer, user at a retail location or warehouse, or other entities or users accessing the retail application 102. For example, user devices 104a and/or 104b may be mobile devices or other computing devices used by a consumer or end customer to access the retail application 102 to order products for delivery by UAV. User device 104a may also be a device used by a retailer or other party to prepare an order for delivery. For example, the user device 104a may be a handheld device used by personnel at a retail location or warehouse to locate items in the order.

In various implementations, the user devices 104a and 104b and/or additional user devices may be implemented using any number of computing devices including, but not limited to, a computer, a laptop, tablet, mobile phone, smart phone, wearable device (e.g., AR/VR headset, smart watch, smart glasses, or the like), smart speaker, vehicle (e.g., automobile), or appliance. Generally, the user devices may include one or more processors, such as a central processing unit (CPU) and/or graphics processing unit (GPU). The user devices may generally perform operations by executing executable instructions (e.g., software) using the processor(s). Though two user devices 104a and 104b are shown in FIG. 1, any number of user devices may be in communication with the retail application 102, in various examples.

UAVs 106 may generally be used to fulfill or deliver orders placed using the retail application 102. In various examples, UAVs may include uncrewed aerial systems (UAS) and the terms may be used interchangeable herein. The UAV 106 may, in various examples, be a fixed-wing aircraft with redundant propulsion systems optimized for long range flight. Other types of UAVs may be utilized, such as quad rotor aircraft, hybrid fixed-wing aircraft, fixed-wing aircraft including horizontal and vertical motors, blimps, balloons, gliders, helicopters, or other aircraft. In some examples, the retail application 102 may utilize multiple types of UAVs. For example, some UAVs may have a longer range or a larger carrying capacity and may, accordingly, be used to deliver orders over a longer distance or larger orders. In yet other embodiments, the vehicles may be ground based vehicles (both manned and unmanned) that may be used deliver goods, e.g., self-driving automobiles, robotic vehicles, or like. As mentioned above, in other examples, the delivery vehicle may be a manned vehicle (e.g. automobile driven by a human).

The network 108 may be implemented using one or more of various systems and protocols for communications between computing devices. In various embodiments, the network 108 or various portions of the network 108 may be implemented using the Internet, a local area network (LAN), a wide area network (WAN), and/or other networks. In addition to traditional data networking protocols, in some embodiments, data may be communicated according to protocols and/or standards including near field communication (NFC), Bluetooth, cellular connections, and the like.

Though not shown in FIG. 1, the retail application 102 may be in communication with other systems or components. For example, the retail application 102 may communicate with retailer systems, payment services, authentication services, and the like. The retail application 102 may, for example, communicate with retailer systems to obtain information about products, including size information, availability, and the like. For example, the retail application 102 may interface with a retailer storage database, such as through an application program interface, to receive data corresponding to the various products. Or in other embodiments, the retail application 102 may be directly connected the retailer storage database.

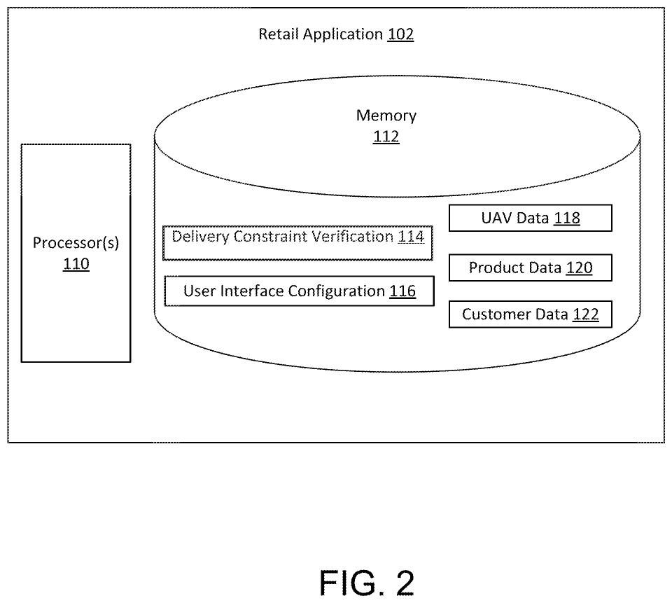

FIG. 2 illustrates a schematic diagram of an example retail application 102, in accordance with various examples described herein. In various implementations, the retail application 102 may include or utilize one or more hosts or combinations of compute resources, which may be located, for example, at one or more servers, cloud computing platforms, computing clusters, and the like. Generally, the retail application 102 is implemented by compute resources including hardware for memory 112 and one or more processors 110. For example, the retail application 102 may utilize or include one or more processors, such as a CPU, GPU, and/or programmable or configurable logic. In some embodiments, various components of the retail application 102 may be distributed across various computing resources, such that components of the retail application 102 may communicate with one another through the network 108 or using other communications protocols. For example, in some embodiments, the retail application 102 may be implemented as a serverless service, where computing resources for various components of the retail application 102 may be located across various computing environments (e.g., cloud platforms) and may be reallocated dynamically and/or automatically according to, for example, resource usage of the retail application 102. In various implementations, the retail application 102 may be implemented using organizational processing constructs such as functions implemented by worker elements allocated with compute resources, containers, virtual machines, and the like.

The memory 112 may include instructions for various functions of the retail application 102 which, when executed by processor 110, perform various functions of the retail application 102. The memory 112 may further store data and/or instructions for retrieving data used by the retail application 102. Similar to the processor 110, memory resources utilized by the retail application 102 may be distributed across various physical computing devices. In some examples, memory 112 may access instructions and/or data from other devices or locations, and such instructions and/or data may be read into memory 112 to implement the retail application 102.

The memory 112 may include or access various types of data used by the retail application 102. While such data is shown in FIG. 2 as being stored at the memory 112, in some examples, data may be stored at other memory resources of the retail application 102 and/or at locations remote from the retail application 102, such as various databases or datastores. In such examples, the memory 112 of the retail application 102 may include instructions for accessing such data from remote locations, including, for example, the locations of the data and/or specific queries used to retrieve data for use by the retail application 102. Such data may include UAV data 118, product data 120, and customer data 122, in various examples.

Delivery constraint data may include UAV data 118, which may generally include data about UAVs 106 utilized by the retail application 102 for delivery of products. Such data may include types of UAVs, size constraints for the UAVs, range of UAVs, and the like. For example, the retail application 102 may utilize more than one type of UAV for delivery, and such UAVs may have differing ranges for delivery and/or size constraints for items which may be delivered. Range may generally include a distance within which the UAV is able to deliver products. Size constraints may include both weight constraints (e.g., the maximum total weight of an order that may be delivered by the UAV) and/or dimensional constraints (e.g., the total height, length, and width of an area of the UAV able to carry products in an order). As one example, the weight constraints may be determined by the weight of the UAV in light of a maximum safety weight that can be added to the UAV without a substantial decrease or degradation in performance, e.g. does not hinder the UAV's ability to take-off, land, and/or maneuver safely. The weight threshold may vary based on different types of UAVs and/or based on the specific instances of the UAV at the time, such as the number of battery cells or fuel levels included on-board. Similarly, the dimensional constraints may be determined dynamically as well as, both based on the payload area of the UAV type and/or the payload area of the specific UAV (accounting for variations due to different modular elements or features of a specific UAV). As such, although the capacity and payload constraints (weight and dimension) may be generally determined based on generic specifications for the type of UAV used for the delivery, they may also be tailored to individual characteristics of the selected UAV to be used or likely used for the delivery.

In some instances, the constraint data may include constraints of a packaging for the order, such as a volume or size of a box or other container that may be required to deliver the order. In this case, the constraint data may include thresholds for product volume or size and/or weight, such as including a threshold size and volume for a particular package type that will be used or could be used with the order. The constraint data may be determined based on information provided from the shipper or delivery platform (e.g., expected packaging or packaging options) and/or may include user preferences as well. For example, the user can input a desired number of packages and/or packaging size that can be used to provide the constraint assessment.

Product data 120 may include identifiers for products available through a retailer. For example, product data 120 may include SKU numbers or other identifiers of products (e.g. description) that can be used to allow a user to identify a desired product from a retailer inventory for delivery. Product data 120 may further include categories for particular products (e.g., toiletries, food products, health products, and others), which may be utilized by the retail application 102 to filter products or otherwise display various products to a user through a user interface. For example, the user interface may include options to view a certain category of products, and the retail application 102 may utilize product categories to determine which products to display for various selections. Product data 120 may, in some examples, include shipping conditions for particular products. For example, shipping conditions may include requirements for additional materials for shipping, restrictions on the combination of the product with other products, and the like. For example, shipping conditions for cold or frozen products, such as ice cream, may include the inclusion of material intended to keep the product cold during transport. Restrictions on the combination of cold products may include restrictions on including the cold products and heated products in the same order.

Product data 120 may further include size information for products available for sale through a retailer. Size information may include weight of the product and/or dimensions of the product. In some examples, such weight and/or dimension may include packaging or other materials used to ship products. For example, size information for products shipped with additional materials (e.g., cold products, breakable products, and the like) may include the weight and/or dimensions of the additional materials (e.g., shipping accessories or packaging materials). In some examples, weights and/or dimensions included as product data 120 may be slightly larger than actual weights and/or dimensions to accommodate for variations in products and to provide a buffer to ensure that size or capacity restrictions are not exceeded. In other words, a buffer value or percentage may be used to increase the product data 120 to define a tolerance to help prevent fit issues in the event that a particular product may be slightly off (e.g. larger) than the general product data 120 described for the product.

Customer data 122 may generally include information about a consumer user of the retail application 102 such as location, access credentials, associated orders, and the like. For example, items in an order in progress for a particular customer may be stored as customer data 122. Customer order history may also be used by the retail application 102 in various examples. A customer's order history may be used to suggest items to the customer to add to an order. For example, where a customer has completed several orders including the same item weekly, the retail application 102 may suggest that the customer add the item to their order.

In various examples, the memory 112 may include instructions for user interface configuration 116. Such instructions for user interface configuration 116 may, when executed by the processor 110, generate user interfaces of the retail application 102 (e.g., user interfaces presented to consumers, retailers, and other users), communicate with user devices to display such user interfaces, and receive information provided to the retail application 102 via such user interface. User interface configuration 116 may further communicate with other components of the retail application 102 to generate such user interfaces and/or to provide information or data collected through such user interfaces.

The memory 112 may further include instructions for delivery constraint verification 114. Delivery constraint verification 114 may generally determine if adding an item to an established order will exceed one or more delivery constraints of a UAV. To verify that an order will fit within the capacity and payload constraints of a UAV, delivery constraint verification 114 may generally use a bin packing algorithm to determine if an item will fit within a payload space of a UAV, given other items already added to the order. The bin packing algorithm may use one or more geometric optimizations to fit the combination or individual product dimensions within the payload dimensional constraints of the UAV, e.g., by assessing various orientations and configurations of the proposed products. The algorithm may receive, as inputs, items already added to the payload space (e.g., the bin), along with corresponding size data for the items already added to the order. Input may further include size information for items offered for sale by the retailer and/or items being added to the order, quantity of such items to be added to the order, and capacity or payload constraints of the UAV. In some examples, delivery constraint verification 114 may include verification that products comply with more than one delivery constraint of the UAV. For example, delivery constraint verification 114 may verify that products fit within both weight constraints and dimensional constraints of the UAV. It should be noted that in many configurations the delivery constraint verification 114 may use an assessment, where as long as one of the constraints is violated, the capacity may not be verified. This is because in most instances the order must satisfy multiple delivery constraints. For example, the order may be required to both fit dimensionally and weight-wise in the UAV.

The components shown in FIG. 2 are exemplary only. In various examples, the retail application 102 may communicate with and/or include additional components and/or functionality not shown in FIG. 2. For example, the retail application 102 may include separate components for communication with retailer systems and/or systems used to manage UAV fleets. In some examples, the retail application 102 may include additional components for authentication, to, for example, allow customers to log in to the retail application 102 using an account associated with the customer.

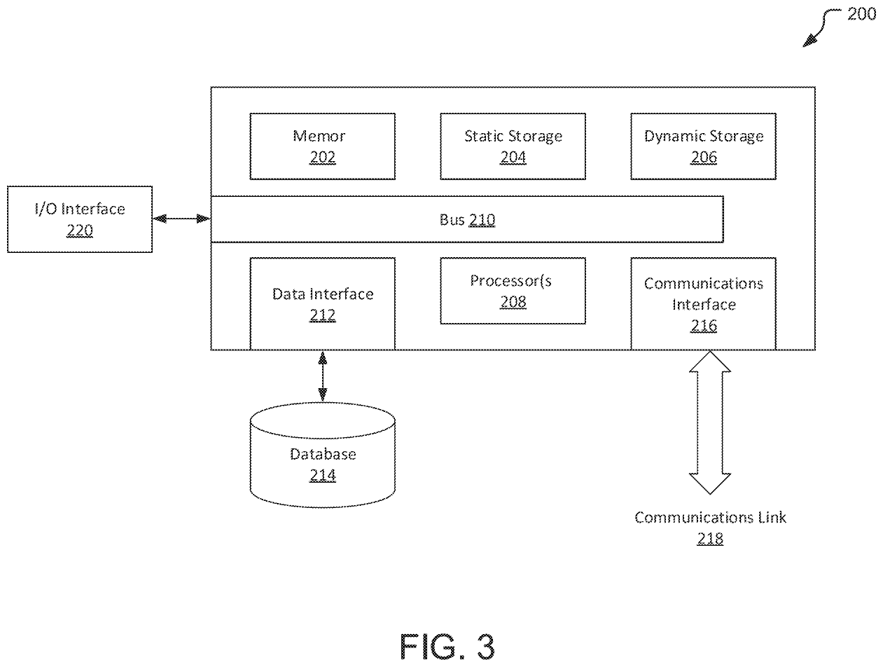

Turning to FIG. 3, an example computing system 200 may be used for implementing various embodiments in the examples described herein. For example, processor 110 and memory 112 may be located at one or several computing systems 200. In various embodiments, user devices 104a and 104b are also implemented by a computing system 200. This disclosure contemplates any suitable number of computing systems 200. For example, the a computing system 200 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 200 may include one or more computing systems; be unitary or distributed; span multiple locations; span multiple machines; span multiple data centers; or reside in a cloud, which may include one or more cloud components in one or more networks.

Computing system 200 includes a bus 210 (e.g., an address bus and a data bus) or other communication mechanism for communicating information, which interconnects subsystems and devices, such as processor 208, memory 202 (e.g., RAM), static storage 204 (e.g., ROM), dynamic storage 206 (e.g., magnetic or optical), communications interface 216 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 220 (e.g., keyboard, keypad, mouse, microphone). In particular embodiments, the computing system 200 may include one or more of any such components.

In particular embodiments, processor 208 includes hardware for executing instructions, such as those making up a computer program. The processor 208 circuitry includes circuitry for performing various processing functions, such as executing specific software for perform specific calculations or tasks. In particular embodiments, I/O interface 220 includes hardware, software, or both, providing one or more interfaces for communication between computing system 200 and one or more I/O devices. Computing system 200 may include one or more of these I/O devices, where appropriate. One or more of these I/O devices may enable communication between a person and computing system 200.

In particular embodiments, communications interface 216 includes hardware, software, or both providing one or more interfaces for communication (such as, for example, packet-based communication) between computing system 200 and one or more other computer systems or one or more networks. One or more memory buses (which may each include an address bus and a data bus) may couple processor 208 to memory 202. Bus 210 may include one or more memory buses, as described below. In particular embodiments, one or more memory management units (MMUs) reside between processor 208 and memory 202 and facilitate accesses to memory 202 requested by processor 208. In particular embodiments, bus 210 includes hardware, software, or both coupling components of computing system 200 to each other.

According to particular embodiments, computing system 200 performs specific operations by processor 208 executing one or more sequences of one or more instructions contained in memory 202. For example, instructions for delivery constraint verification 114 and user interface configuration 116 may be contained in memory 202 and may be executed by the processor 208. Such instructions may be read into memory 202 from another computer readable/usable medium, such as static storage 204 or dynamic storage 206. In alternative embodiments, hard-wired circuitry may be used in place of or in combination with software instructions. Thus, particular embodiments are not limited to any specific combination of hardware circuitry and/or software. In various embodiments, the term “logic” means any combination of software or hardware that is used to implement all or part of particular embodiments disclosed herein.

The term “computer readable medium” or “computer usable medium” as used herein refers to any medium that participates in providing instructions to processor 208 for execution. Such a medium may take many forms, including but not limited to, nonvolatile media and volatile media. Non-volatile media includes, for example, optical or magnetic disks, such as static storage 204 or dynamic storage 206. Volatile media includes dynamic memory, such as memory 202.

Computing system 200 may transmit and receive messages, data, and instructions, including program, e.g., application code, through communications link 218 and communications interface 216. Received program code may be executed by processor 208 as it is received, and/or stored in static storage 204 or dynamic storage 206, or other storage for later execution. A database 214 may be used to store data accessible by the computing system 200 by way of data interface 212. For example, UAV data 118, product data 120, and/or customer data 122 may each be stored using a database 214 (e.g. a retailer database including available inventory for ordering by users). In various examples, communications link 218 may communicate with, for example, user devices to display user interfaces to the retail application 102.

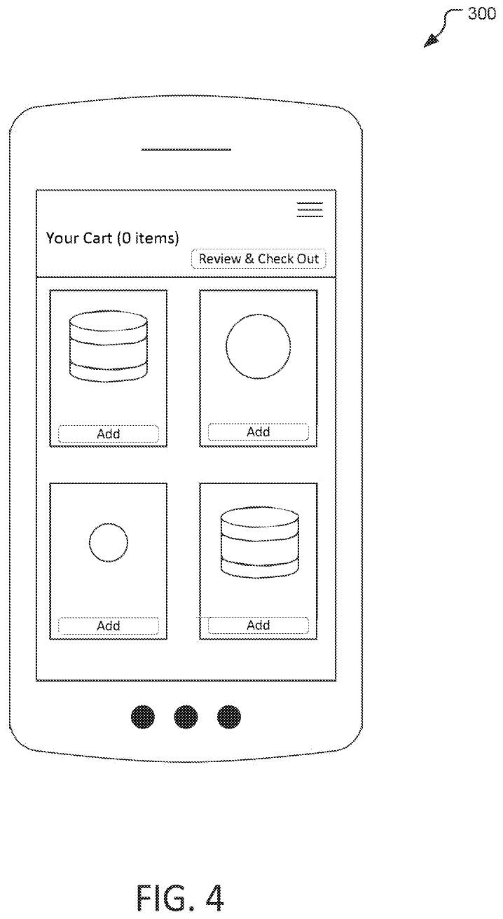

FIG. 4 shows an example user interface 300 of the retail application 102. The user interface 300 of the retail application 102 may generally be generated and/or configured by user interface configuration 116 of the retail application 102 and may be displayed at a user device 104a and/or 104b in communication with the retail application 102. The user interface 300 may generally be displayed to a customer responsive to a request to view products available for delivery to the customer by UAV. For example, a customer may request, through a previous user interface of the retail application 102, to begin an order through a retailer. The retail application 102 may then pull product data 120 to identify products available through the retailer for delivery to the customer by UAV.

As shown, the user interface 400 may generally include representations of each product (e.g., item) available for delivery, such as by UAV. For example, representations may include images, descriptions, names, product count, and/or other information about individual products. Such representations may be displayed with selectable elements (e.g., selectable buttons) which, when selected, add the associated item to the customer's order.

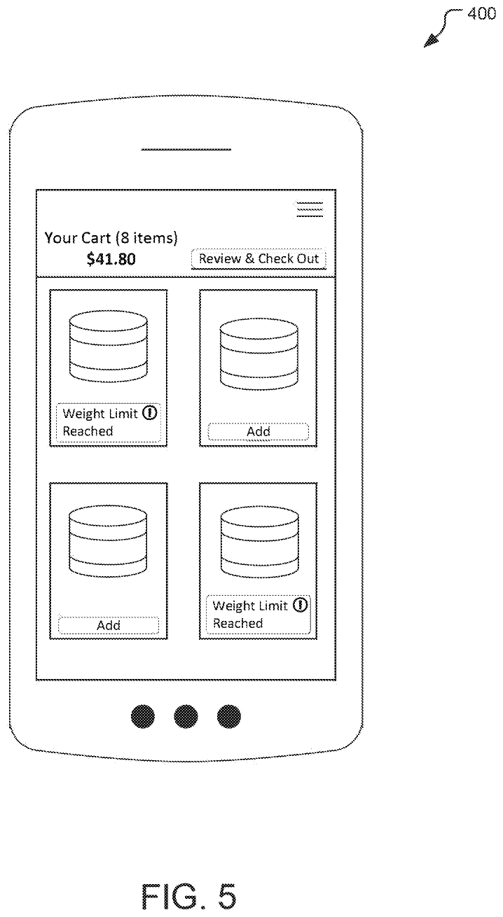

FIG. 5 shows an additional example user interface 400 of the retail application 102. The user interface 400 may generally be generated and/or configured by user interface configuration 116 of the retail application 102. The user interface 400 may be displayed at a user device 104a and/or 104b in communication with the retail application. The user interface 400 may be displayed after the customer has added a number of items to the order in progress, as reflected, for example, by the count of the number of items in the customer's cart shown at the user interface 400.

In some examples, after each item is added to an order, the retail application 102 may re-evaluate whether each of the products displayed at the user interface 400 are still able to be added to the order. That is, the retail application 102 may determine whether a product, based on its size (e.g., weight and/or dimensions) will exceed capacity limits or other delivery constraints of the UAV based on the products already added to the order. In some examples, the retail application 102 may be presented as a webpage within a web browser. In such examples, the evaluation of whether a product may be added to an order may be a dynamic calculation taking place in the browser as the webpage is rendering. For example, a product which, if added to the order, will cause the order to violate any delivery constraints for a viable UAV delivery, may not be able to be added to the order. Such products may be referred to herein as being unviable. The retail application 102 may then re-generate (e.g., configure anew) the user interface 400 to reflect the unviable items. For example, reflecting the unviable items may include displaying representations of items with indicators (e.g., elements) that the items are unviable. As shown in FIG. 4, such elements may include text stating that the weight limit for the UAV has been reached, and that adding the product to the order would cause the order to exceed the weight limit for the UAV. Products which may still be added to the order (e.g., viable items which, when added to the order, will not cause the order to exceed delivery constraints of the UAV) may continue to be displayed with selectable elements allowing such products and/or items to be added to the order.

In various examples, the elements indicating that products are unviable may not be selectable. For example, where an “add to order” button would usually be located for a viable product, a greyed out button saying “weight limit exceeded” or other similar message may be presented with an unviable product. In some examples, an element indicating that a product is undeliverable may obscure a view of the undeliverable product. In some examples, the elements may be selectable and, when selected, may lead the customer to another interface explaining capacity limits and/or allowing the customer to remove existing items from the order to allow the customer to add the undeliverable product to the order. For example, the additional interface may identify particular items already in the order that may be removed to accommodate the undeliverable item. Stated differently, the retail application 102 may suggest swaps for the order for the order to stay under capacity limits of the UAV. In some examples, the elements, when selected, may indicate that a second UAV would be required to deliver the undeliverable item, which may incur additional fees. The customer may be given an option to add an additional UAV for delivering the order or to split the order between the UAV and another delivery method.

In some examples, such interfaces may include indications that adding a product to the order would exceed a delivery constraint made based on customer preference. For example, including the item would cause the order to be split between two delivery vehicles or would use an amount of packaging above a threshold volume selected by the customer. In these examples, the customer may be allowed to override the delivery constraints made based on customer preference. That is, the customer may consent to an order being split between two UAVs where the customer had previously selected a preference for use of only one UAV.

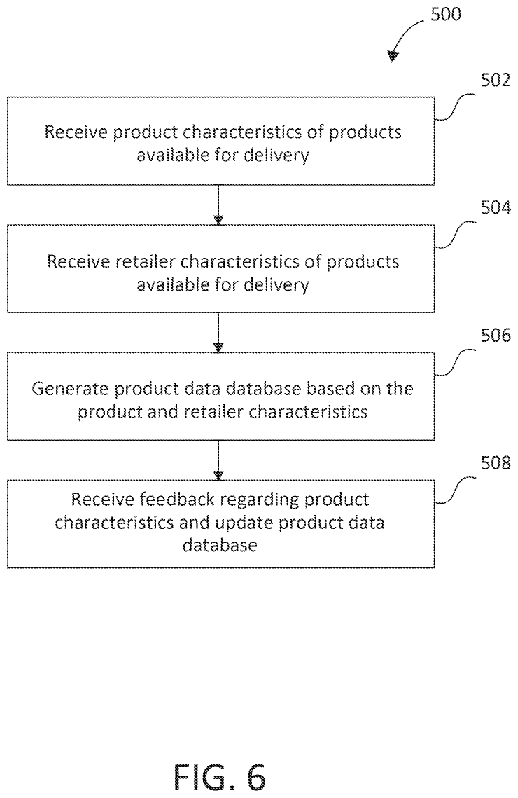

FIG. 6 is a flow diagram of operations 500 for generating the product data used for delivery constraint verification 114 of the retail application 102. At block 502, the retail application 102 receives the product characteristics of the products available for delivery. Such product characteristics may include product identifiers and the weight and dimensions of the products. Product characteristics may also include temperature requirements for the products. For example, a product that requires storage at a certain temperature range may require shipping with other products of like temperature (e.g., within a range or threshold of the selected product). Product characteristics may also include whether the products include any fragile or hazardous material, e.g., fragile items such as glass may not be shipped with heavy items, such as large fluid containers, or biological samples may not be included with edible or consumable products.

Product characteristics may be directly obtained from the retailer and/or measured by the fleet management or other third party systems. In some examples, the retailer may provide the retail application 102 with the product characteristic information (e.g., through an API or access to a database or direct data input). In other examples, product characteristics may be ascertained through data collection or measurement and subsequently provided to the retail application 102. For example, the weight of the product may be measured by the UAV when the product is placed into the UAV cargo space, and the dimension of the product may be measured through lidar scans or other sensor measurements to identify shape and weight or volume information.

In some examples, product characteristics may further include regulatory or manufacturer requirements for certain products. For example, certain hazmat products may be subject to shipping and storage regulations. As another example, pharmaceutical products may be subject to manufacturer requirements regarding temperature or contamination levels during shipment. Such product characteristics may be obtained directly from the retailer or manufacturer or from a database of relevant regulations.

At block 504, the retail application 102 receives retailer characteristics of the products available for delivery. Such retail characteristics may include packaging and shipping preferences of the retailers, user experience preferences of the retailers, or any other requirements that are individual to the retailers. For example, retailers may require certain types of packaging for different products or require that certain products are shipped on their own.

Retailer characteristics may be directly obtained from the retailer. In some examples, the retailer may provide the retail application 102 with the retailer characteristic information. For example, a retailer may provide retailer characteristics to the retail application 102 through an API or direct access to a database.

At block 506, the retail application 102 generates the product data 120 database based on the product and retailer characteristics and stores the product data 120 in memory 112. The product data 120 includes the product characteristics and retailer characteristics that may be relevant to UAV shipment for products available for delivery. In some examples, generating the product data 120 may entail updating the existing product data 120 to reflect any changes in product or retailer characteristics. For example, if a new or updated regulation on hazmat materials affects products recorded in product data 120, the revised product characteristics for the affected products received from block 502 may be used to update the product data 120. As another example, if product data 120 included a requirement from a prescription manufacturer that a certain prescription be transported below 20° C. and the manufacturer changed the requirement to require transportation below 15° C., the product data 120 may be updated to reflect the new requirement.

At block 508, the retail application 102 receives feedback regarding the product characteristics and updates the product data 120 database. In some examples, where the retail application 102 receives repeated feedback of shipping issues for certain products, for example, that the actual size of the product is larger than the dimensions recorded in the product data 120, causing the order to exceed capacity or payload constraints, the feedback may be used to update the dimension characteristics for that product. The feedback may be provided manually by users or employees of the retailers or fleet management or may be provided from analysis by the retail application 102. For example, as a UAV is being loaded with items from a retailer after the delivery constraint verification 114 has determined that the order is viable, a retailer employee may note that the payload does not fit into the cargo space and provide feedback to the retail application 102 that the order was not viable. As another example, where the retail application 102 has received multiple notices that orders did not fit within capacity constraints, the retail application may analytically determine which items in the order are causing the issue and update the product data 120 to reflect the accurate dimensions of the items.

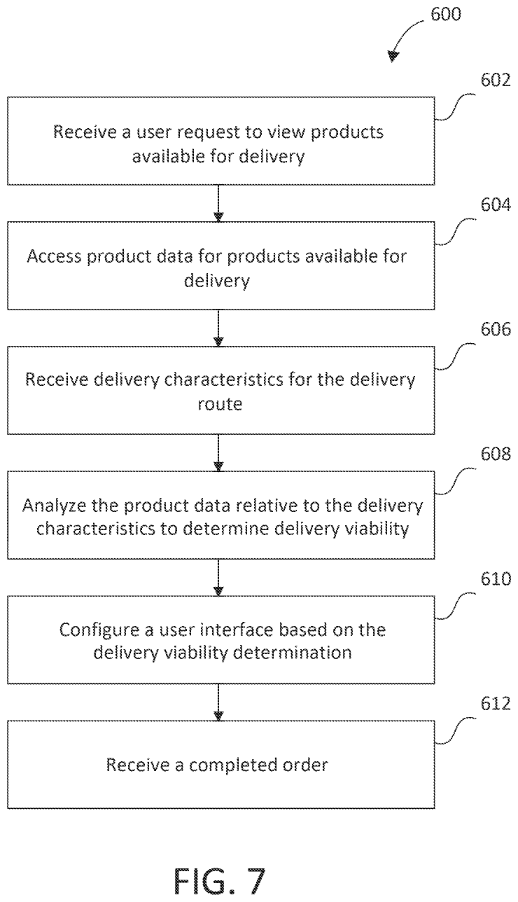

FIG. 7 is a flow diagram of operations 600 for rendering a user interface (e.g., user interface 300 and/or 400) of the retail application 102. At block 602, the retail application 102 receives a user request to view a user interface including products available for delivery by a UAV. Such a request may include selection of a retailer for placing an order for delivery by UAV or other request to begin a new order for delivery by UAV through the retail application 102. The request may also be a request to continue an in-progress order. For example, after adding an item to an order, a customer may request to continue shopping (e.g., add more items to the order after closing the application or otherwise having delayed completing an earlier order). In some examples, the user interface may automatically reload after the customer adds a new item to an order and does not request to complete the order (e.g., check out). The request may generally be provided through a user interface at a user device 104a or 104b and may be received by the retail application 102 at user interface configuration 116.

The products available for delivery by UAV may generally include all products that a retailer (or multiple retailers) offers for delivery by UAV. Such products may include, in various examples, products that may or may not be viable for the UAV delivery. For example, products that a retailer allows to be delivered by UAV may be displayed, regardless of whether adding such products to an existing order would exceed any delivery constraints of the UAV. The catalog of products available for delivery may be stored in product data 120 or retrieve from an existing database or other data storage.

At block 604, the retail application 102 accesses the product data 120 associated with the products available for delivery from memory 112. Product data 120 may include identifiers for products. In some examples, the identifiers may be SKU numbers. Product data 120 may also include product characteristics such as, for example, weight, dimensions, temperature restrictions, or fragile or hazardous contents. Product data 120 may also include retailer characteristics such as, for example, packaging, shipping, or user experience preferences of the retailer.

At block 606, the retail application 102 receives delivery characteristics for the delivery route. The delivery route is the designated route for the UAV to complete the delivery of the products. For example, the delivery route may start at a location where the products are stored, such as a retailer location or warehouse, and may end at a user location or other selected delivery location. The delivery location may, for example, be input by the user during the ordering process, suggested to the user from a customer profile, or determined by the GPS location of the user device 104a or 104b that placed the order.

Delivery characteristics include characteristics associated with the specified delivery route which may impact UAV capacity considerations. For example, delivery characteristics may include the distance of the route, the weather and temperature along the route, the battery charge required to complete the route, altitude changes along the route, and any notable topographic features along the route.

In some examples, delivery characteristics include characteristics of the UAV used for the delivery. For example, the delivery characteristics may include the weight and dimensional limits for the UAV or the battery charge and range limits for the UAV. For example, a weight limit may be a maximum weight of items able to be carried by the UAV. Dimensional limits may include a total length, width, and height available to carry payload by the UAV. Such dimensional limits may further include a shape of a volume able to carry payload at the UAV. In various examples, dimensional limits may be based on a single dimension. For example, if a product exceeds one dimension of the dimensional limit, the product exceeds the dimensional limits, regardless of the other dimensions of the product. A rectangular product may exceed the dimensional limits where the height of the product exceeds a height of a payload volume of the UAV. The product may not exceed the dimensional limit where the height would not exceed another dimension of the UAV (e.g., the product would fit in the UAV if placed in another configuration).

In some examples, the retail application 102 may receive the UAV characteristics by querying the UAV data 118 from memory 112. In other examples, UAV characteristics, such as capacity limits of the UAV, may be obtained from a UAV fleet management database that assigns individual UAVs for delivery. The fleet management database may further include generic UAV features, such as type of UAV, generic payload capacity an individual characteristics for particular UAVs, such as a number of battery cells or other characteristics that may limit or vary the generic characteristics for the UAV.

At block 608, the retail application 102 analyzes the product data 120 relative to the delivery characteristics for the products available for delivery to determine delivery viability. Products which exceed or violate one or more delivery constraints may be designated as unviable for the UAV delivery. Products which are not viable for delivery may generally be identified by delivery constraint verification 114 of the retail application 102. For example, delivery constraint verification 114 may access customer data 122 to determine which items are already added to an order. For each product of the plurality of products, delivery constraint verification 114 may compare the product characteristics, delivery characteristics, and retailer characteristics to determine whether each item would exceed or violate the delivery constraints for the UAV when added to the items already in the order. Delivery constraint verification 114 may, for example, provide capacity limits for the UAV, size data for a product, and size data for products already in an order to a bin packing algorithm to determine whether the product will cause the order to exceed the capacity limits for the UAV. Products which would cause the order to exceed or violate delivery constraints for the UAV may be referred to as unviable products (e.g., the products may not be added to the order without removing one or more existing products from the order), while products which would not cause the order to exceed or violate delivery constraints for the UAV may be referred to as viable products.

At block 610, the retail application 102 configures the user interface including the products based on the delivery viability determination. The user interface may generally be displayed at the user device 104a or 104b and may be configured by user interface configuration 116 based on output from delivery constraint verification 114 and/or other data stored at or obtained by the retail application 102. For example, user interface configuration 116 may receive, for each product available from a retailer, output from delivery constraint verification 114 indicating that the product is either viable or unviable. User interface configuration 116 may further retrieve product representations or identifiers (e.g., photos of products, descriptions of products, and the like) from product data 120. User interface configuration 116 may then communicate with the user device 104a or 104b to display the user interface at the user device 104a or 104b. For example, user interfaces 300 and/or 400 may be displayed at user devices 104a or 104b.

User interface configuration 116 may configure the user interface to provide notice to a user when a product is not viable for a current UAV delivery. In some examples, the user interface is configured to notify the user of any unviable products in their order at the check-out or final review phase of the ordering process. In such examples, the user interface may be configured to restrict check-out or order completion while there are unviable products in the order. In other examples, if there are unviable products in the order the user interface may be configured to offer options to split the order delivery between multiple UAVs or between a UAV and a different delivery method in order to facilitate delivery of the unviable products.

In other examples, the user interface is configured to dynamically notify the user of any unviable products during the order process. For example, the user interface can notify the user that a product is unviable before the product is placed into the order, or the user interface can notify the user that a product is unviable when the user attempts to place the product in the order. For example, viable products may be displayed with elements allowing the products to be added to the order. In some examples, a product may be viable when adding one of the product to the order would not exceed capacity limits or other delivery constraints of the UAV. In such examples, if a customer attempts to add multiples of the product to the order, the product may become unviable and the user interface may update to inform the customer that multiples of the product may not be added to the order without exceeding capacity limits or other delivery constraints of the UAV.

The user interface generally displays unviable products with some indicator that the unviable products may not be added to the current order for delivery by UAV. For example, an element stating that adding the product to the order would cause the order to exceed capacity limits of the UAV may be displayed with the representation of the item. In some examples, such elements may not be selectable. In some examples, such elements may be selectable to view additional information about the order and/or the capacity limits. For example, the retail application 102 may suggest removing one or more products from the existing order in order to add an otherwise undeliverable product to the order. The retail application 102 may further display information reflecting that a lower quantity of the item may be added to the order without exceeding capacity limits of the UAV. In other examples, the user interface may display an option to split the delivery between multiple UAVs or between a UAV and a different delivery method to facilitate delivery of previously unviable products. In such examples, users may add unviable products to the order if the products would no longer violate any delivery constraints when alternate delivery methods are selected.

In some examples, viable products may be displayed with elements which, when selected through the user interface, allow the viable products to be added to the order. When a viable product is added to the order, customer data 122 may update to reflect that the order includes the newly added product. The operations 602 through 610 may then be repeated where, for example, a user selects an option to continue shopping or does not select an option to checkout or otherwise finalize the order.

In some examples, when a customer finalizes an order (e.g., by selecting an option to check out through the retail application 102), the retail application 102 may suggest that the customer add additional products to the order to put the size of the order closer to the capacity limits of the UAV. Such suggested items may, in various examples, be chosen based on items previously ordered by the customer, which may be stored as customer data 122. Suggested items may also be, in some examples, based on items that the customer has recently searched for or viewed through the retail application 102. Accordingly, customers may be encouraged to consolidate orders instead of placing multiple orders below capacity of the UAV, reducing deliveries to individual consumers and ultimately reducing resource usage (e.g., fuel, protective packaging, and the like).

At block 612, the retail application 102 receives a completed order for delivery. The completed order contains products which are viable for delivery and do not exceed the constraints for the UAV delivery.

Accordingly, the retail application 102 described herein addresses particular challenges presented by delivery of consumer products with UAVs. For example, UAVs may have capacity limits impacted by individual order sizes, unlike other vehicles typically used for delivery of consumer products. The retail application 102 may notify customers before completion of an order when products cannot be added to the order, making the ordering process more efficient for customers and reducing transactions which may otherwise refund customers for products which could not be added to an existing order. The retail application 102 may further allow customers to prioritize urgently needed items and may provide a more efficient packing process, as only products which fit into a UAV are picked when an order is placed. The retail application 102 accordingly provides for an improved experience for customers ordering products for delivery by UAV and makes the process of delivery by UAV more efficient.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A computer implemented method comprising:
receiving, from a user device, a request to view a user interface including a plurality of products for delivery by an unmanned aerial vehicle (UAV) as part of an order associated with the user device;
identifying, from the plurality of products, one or more unviable products, the one or more unviable products being identified based on the order, one or more delivery constraints of the UAV, and one or more characteristics of the plurality of products, wherein the delivery constraints of the UAV include one or more capacity limits of the UAV; and
displaying, at the user device, the user interface including the plurality of products, the one or more unviable products being displayed with indicators that the one or more unviable products will exceed the delivery constraints of the UAV.

2. The method of claim 1, wherein the one or more of weights and dimensions of the one or more unviable products exceed the one or more delivery constraints of the UAV.

3. The method of claim 1, wherein the one or more delivery constraints include one or more of total weight capacity of the UAV and dimensions of a payload area of the UAV.

4. The method of claim 1, wherein unviable products are further identified based on characteristics of the delivery route.

5. The method of claim 4, wherein the characteristics of the delivery route include one or more of fuel amount required to complete the route, weather and temperature conditions along the route, topographic features along the route, and altitude changes within the route.

6. The method of claim 1, wherein the one or more characteristics of the plurality of products include transport temperature requirements of the products.

7. The method of claim 1, wherein the one or more characteristics of the plurality of products include regulatory or manufacturer requirements of the products.

8. The method of claim 1, wherein the one or more characteristics of the plurality of products include one or more of the shipping, packaging, and user experience requirements of the retailers of the products.

9. The method of claim 1, wherein the one or more of weights and dimensions of the plurality of products are obtained from a retailer offering the plurality of products for sale.

10. The method of claim 1, wherein the one or more weights and dimensions of the plurality of products are obtained by measurements conducted by the UAV or UAV fleet management.

11. The method of claim 1, further comprising:
identifying one or more viable products from the plurality of products, wherein the one or more of weight or dimensions of the one or more viable products do not exceed the one or more capacity limits of the UAV; and
wherein displaying at the user device, the plurality of products comprises displaying the one or more viable products with elements which, when selected through the user interface, allow the viable products to be added to the order.

12. The method of claim 11, wherein the viable and unviable products are determined using a bin packing algorithm.

13. The method of claim 12, wherein the bin packing algorithm calculates how multiple products fit within one space.

14. The method of claim 11, further comprising:
updating, responsive to selecting one of the viable products by selecting a corresponding element of the elements, the order; and
identifying one or more additional unviable products from the viable products based on the updated order.

15. The method of claim 14, further comprising:
dynamically updating the display on the user device to reflect the one or more additional unviable products.

16. A computer implemented method comprising:
displaying on a user device a plurality of products available for delivery;
receiving a user input to add a new product from the plurality of products to an order;
analyzing product data from one or more products in the order and the new product in light of one or more delivery constraints;
determining that the order with the addition of the new product will exceed the one or more delivery constraints;
generating a user notification on the user device to indicate that the addition of the new product will exceed the one or more delivery constraints.

17. The method of claim 16, wherein the one or more delivery constraints comprise at least one of a vehicle constraint or a packaging constraint.

18. The method of claim 17, wherein the packaging constraint is based on a user preference regarding a packaging size or a packaging amount.

19. The method of claim 16, further comprising prohibiting addition of the new product to the order.

20. The method of claim 16, further comprising generating a selectable option to add one or more delivery vehicles of the same or different type so that addition of the new product will comply with the one or more delivery constraints.

21. The method of claim 16, wherein the delivery is by an unnamed aerial vehicle.
